(19) United States
(12) Patent Application Publication
(10) Pub. No.: US 2011/0239886 A1
(43) Pub. Date: Oct. 6, 2011

(54) SECURITY DEVICE COMPRISING A PRINTED METAL LAYER IN FORM OF A PATTERN AND METHODS FOR ITS MANUFACTURE

(75) Inventor: Brian William Holmes, Fleet (GB)

(73) Assignee: DE LA RUE INTERNATIONAL LIMITED, Hampshire (GB)

(21) Appl. No.: 13/124,565

(22) PCT Filed: Oct. 26, 2009
(86) PCT No.: PCT/GB2009/002551

§ 371 Date: Jun. 17, 2011

(30) Foreign Application Priority Data
Oct. 27, 2008 (GB) PCT GB2008 003634

(51) Int. Cl. B41F 33/00; B42D 15/00

(52) U.S. Cl. 101/483; 283/85

(57) ABSTRACT

A security device including a transparent base layer having a surface provided with an optically variable relief microstructure; a transparent high refractive index layer on the surface of the base layer, the high refractive index layer conforming to the surface relief microstructure; and a reflective metal layer printed on the transparent high refractive index layer. The metal layer is printed in the form of a pattern. The thickness of the transparent high refractive index layer is selected so as to achieve constructive interference of light with a wavelength λ in the range 450-650 nm reflected at each surface of the high refractive index layer.

The invention relates to a security device and methods for its manufacture.

In particular, the invention relates to security devices in the form of holograms and/or DOVIDS (Diffractive Optically Variable Identification Devices) which find wide application with articles and documents of value.

In a conventional security device of this kind, a base layer such as a lacquer or resin is provided with an optically variable relief microstructure onto which a metal layer is then vacuum deposited in order to enhance the reflective properties of the device. This metal layer may be selectively demetallized by etching or the like to enable underlying information to be visible when the device is secured to an article or document. The conventional security devices of this kind are relatively expensive to produce due to the complexities of vacuum metallisation and selective etching and an improvement is described in WO 2005/049745 in which a platelet or flake based metallic ink is printed onto the surface relief microstructure as a reflective layer. This is also described in WO-A-2005/051675 and U.S. Pat. No. 5549774.

The use of a printed metallic layer, instead of a vacuum deposited layer, does offer a number of advantages in that it is a simpler and cheaper way of providing a reflection enhancing layer and it enables flexibility in the design of the security device by selectively applying the metal in localised regions. Furthermore, specific additives can be added to the metallic ink (as described in WO 2005/049745) composition to modify its chemicals and/or physical properties. Polychromatic effects can be achieved by the introduction of transparent organic pigments and/or solvent soluble dyestuffs into the ink, to achieve a range of coloured shades.

However, it has been found that such diffractive and holographic devices exhibit relatively poor replay of the diffractive structure due to a lower reflection efficiency from the surface of the platelet or flake metallic ink compared to the specular reflectivity from a vacuum deposited metallic layer. This degradation is due in part to the fact that inks are comprised of a suspension of metal platelets or flakes in a weakly reflective resinous binder. Since the metallic flakes or platelets generally constitute by volume less than 25% of the ink, the reflectivity must intrinsically be less than a continuous metal film. For the case where the metallic flakes or platelets comprise 25% of the ink volume, then at best the reflectivity can only approach 25% of a continuous vacuum deposited metal film. More particularly platelet metal flakes, although superior to conventional metal flakes or pigment, cannot follow the diffractive or holographic surface relief micro-structure as intimately as a vacuum deposited coating. Specifically those micro regions of the relief structure that are contacted by the binder will not make any significant contribution to the diffractive wave-fronts since they will be essentially index matched out due to the similarity in refractive index of embossing layer and binder (n=1.45-1.5). Furthermore there will be a statistical spread in the alignment of the platelets or flakes which will act to further diffuse the diffracted light such that their will be a reduction in the brightness and gloss of the diffractive or holographic image.

WO 2005/049745 attempts to improve the efficiency of such devices by ensuring the ratio of pigment to binder is sufficiently high to permit the alignment of pigment particles to the contours of a diffraction grating, however the resultant replay of the diffractive grating in practice is still not as bright as that observed with a vacuum deposited metallic layer.

JP-A-2008139713 describes a hologram transfer foil made up of a carrier and release layers on which are provided a hologram layer, a transparent reflective layer such as titanium oxide, a high brightness ink layer including metal-vapour deposited film pieces surface treated with organic fatty acid or the like and optionally printed, and an adhesive layer. The purpose of this structure is to avoid corrosion of the metal within the high brightness ink layer. This does not discuss the problem set out above relating to the use of platelet or flake metallic inks nor the problem, more generally, of the effect of the interface between the high brightness metallic layer and the reflective layer which is sufficiently thin to follow the surface relief of the hologram layer.

In accordance with a first aspect of the present invention, a security device comprises a transparent base layer having a surface provided with an optically variable relief microstructure; a transparent high refractive index layer on the said surface of the base layer, the high refractive index layer conforming to the surface relief microstructure; and a reflective metal layer printed on the transparent high refractive index layer, and is characterized in that the metal layer is printed in the form of a pattern; and in that the thickness of the transparent high refractive index layer is selected so as to achieve constructive interference of light with a wavelength λ in the range 450-650 nm reflected at each surface of the high refractive index layer.

In accordance with a second aspect of the present invention, a method of manufacturing a security device comprises providing a transparent base layer with a surface having an optically variable relief microstructure; providing a transparent high refractive index layer on the said surface of the base layer, the high refractive index layer conforming to the surface relief microstructure; and providing a reflective metal layer on the transparent high refractive index layer, and is characterized in that the metal layer is printed in the form of a pattern; and in that the thickness of the transparent high refractive index layer is selected so as to achieve constructive interference of light with a wavelength λ in the range 450-650 nm reflected at each surface of the high refractive index layer.

The invention overcomes the problems mentioned above, particularly in connection with JP-A-2008139713, by enabling a metallic ink pattern to be printed without significant loss of brightness. The inventor has realized that when considering a printed, metallic pattern, it is important to enhance light reflected from regions where metal is printed and this can be done by ensuring that constructive interference takes place between light rays reflected from the metal/high refractive index layer interface and the other surface of the high refractive index layer but that there is destructive interference between light rays reflected from opposite surfaces of the high refractive index layer which are not in line with metal. This then not only enhances brightness of the light reflected from the metallic areas but reduces the replay of the hologram in the other areas thus enhancing still further the visibility of the printed metallic pattern.

By high refractive index, we mean an index of refraction which exceeds that of the transparent, typically embossed, base layer by a numerical value of 0.5 or more. Since the refractive index of the base layer will typically fall in the range of 1.45-1.55 then a high refractive index material will be one with an index of 2.0 or more. In practice high refractive index materials with good visual transparency will have an index in the range 2.0-2.5.

An optimum brightness can be achieved by carefully determining the thickness of the high refractive index layer needed to ensure constructive interference between the two partial amplitudes diffracted off the first and second surfaces of the high refractive index layer. The first surface is that which forms the interface with the surface relief microstructure whilst the second surface is that which forms the interface with the metal layer. The thickness of the high refractive layer required to ensure constructive interference between the partial diffracted amplitudes differs from that needed to ensure constructive interference between partial amplitudes reflected off two strictly planar interfaces and is best determined empirically by practical methods as its precise value depends on the periodicities and amplitudes present in the optically variable microstructure and the incident wavelengths.

In order to achieve destructive interference, where no metal is present, the non-metallic regions of the second surface of the refractive index layer should contact a lower refractive index body. This body will typically be an adhesive but could be air.

The optically variable relief microstructure can have any conventional form and typically comprises a diffraction grating or hologram. However, combinations of these would also be possible. The holographic generating structures can be any structure that generates graphical images by the mechanism of diffraction of light. Such holographic generating structures include those formed by the following non-exhaustive list of techniques: optical interferometry, dot-matrix interferometry, lithographic interferometry or e-beam interferometry.

The base layer can also be made of any conventional material and is typically a lacquer or resin. The optically variable relief microstructure can be embossed into the base layer or formed by a cast/cure process.

Typical examples of materials suitable for the high refractive index layer include zinc sulphide, titanium dioxide & zirconium dioxide.

The metal layer can be formed using any of the techniques and materials described in more detail in WO-A-2005/049745 which is incorporated herein by reference.

Typically, the metal layer is formed from one or more inks containing suitable metallic particles, such as platelets, flakes or lamella, and a binder.

The metallic particles may be derived from metals such as aluminium, copper, zinc, Nickel, chrome, gold, silver, platinum, or any other metals or associated alloys such as copper-aluminium, copper-zinc or nickel-chrome which may be deposited under vacuum. Organic colorants or dyes may be added to the binder to achieve the desired colour.

It is preferable, though not essential to the invention that the metal particles be highly platelet or lamella in nature—that is the dimensions of the metal particles along the axis parallel to the reflective interface (the platelet length) is significantly greater than the dimensions transverse to the reflective interface (the platelet thickness). By “significantly greater” we mean the platelet length should be at least 2-5 times the thickness and desirably more. Platelet thickness depending on the basic method of production may range 10 nm to 100 nm, but for application to holographic or diffractive structures the preferred thickness is in the range 15 nm to 100 nm and more especially 25-50 nm. It is important to ensure that the flake conforms to the shape of the optical microstructure relief with a good spatial fill factor and this can be achieved by choosing that platelet length and width, are such that both dimensions exceed the periodicities present in the optically variable diffractive micro-structure. Consider an ink comprised of a dispersion of Aluminium flakes (25 nm thick) with a length and width of the order of 1000 nm. As the ink dries the metal flakes will contact the grating surface reliefs in a fairly irregular way—however the frequency of the gaps between flakes will decrease ten fold compared with flakes having a length and width of 100 nm thus significantly reducing scatter. Also the fact that the flakes lengths and widths are on average 40 times their thickness means that they are not mechanically stiff enough to be self supporting under the influences of gravity and the compressive forces experienced by the dispersion as it dries or cures. Thus they will tend to conform readily to the shape of the grating reliefs as the inks dries. This improved conformance to the shape of the grating profiles together with the fact that typically each individual flake will without interruption tend to span one grating groove will provide much higher diffraction efficiency than for 100 nm flakes. Further improvement in diffraction efficiency will be delivered by further increases in platelet length and width. Specifically if we regard each diffraction groove as a single secondary source of disturbance within a chain or series of coherent secondary sources (that is the grating array) then it is known from basic diffraction theory that full diffraction efficiency is not achieved until there is an uninterrupted array of 8-10 or more coherent secondary sources i.e. reflective grating grooves. Thus in an exemplary scenario the platelet flakes would have a length or width sufficient to span at least 8-10 grating grooves. Thus for a typical DOVID especially preferred platelet lengths and widths will be of the order 10,000 nm or more.

The binder may comprise any one or more selected from the group comprising nitrocellulose, ethyl cellulose, cellulose acetate, cellulose acetate propionate (CAP), cellulose acetate butyrate (CAB), alcohol soluble propionate (ASP), vinyl chloride, vinyl acetate copolymers, vinyl acetate, vinyl, acrylic, polyurethane, polyamide, rosin ester, hydrocarbon, aldehyde, ketone, urethane, polythyleneterephthalate, terpene phenol, polyolefin, silicone, cellulose, polyamide and rosin ester resins.

Preferably, the binder comprises 50% nitrocellulose 50% polyurethane.

The composition may additionally comprise a solvent. The solvent may be ester/alcohol blends and preferably normal propyl acetate and ethanol. More preferably, the ester/alcohol blend is in a ratio of between 10:1 and 40:1, even more preferably 20:1 to 30:1.

The solvent used in the metallic ink may comprise any one or more of an ester, such as n-propyl acetate, iso-propyl acetate, ethyl acetate, butyl acetate; an alcohol such as ethyl alcohol, industrial methylated spirits, isopropyl alcohol or normal propyl alcohol; a ketone, such as methyl ethyl ketone or acetone; an aromatic hydrocarbon, such as toluene; or water.

The metallic layer will typically be applied to the high refractive index layer by means of a conventional printing press such as gravure, rotogravure, flexographic, lithographic, offset, letterpress intaglio and/or screen process, or other printing processes.

In one approach, the metal layer is printed in the form of a security pattern (a shaped region or regions) which may be registered to pattern(s) generated by the optically variable relief microstructure. The metal pattern could at least in part be comprised of regions of intricate secure pattern work e.g. filigree with minimum graphical dimensions in the order of 50 microns. Such intricate patterning of the metal is beyond the scope of a potential counterfeiter to reproduce or approximate by the technique of hot-stamping using coloured decorative foils.

In some cases, the metal layer is formed by one ink so as to present the same colour across the full area of the security device in a similar way to vacuum or vapour deposited metallic layers. However, a variation in colour across the device or between different regions of the device can be achieved by using metallic inks of differing colours. Different colours may be provided within the metallic inks by adding differing colourants (dyes) to the binder component present or by using metal flakes or particles from differing metallic species (e.g. Copper and Aluminium) or a combination of both. The platelets or flakes may also be comprised of multiple optically thin films and derive their colour from thin film iridescence.

The security device can be used in a wide variety of applications which will be known to persons of ordinary skill in the art. Typically, the security device will be provided on an article such as a security item. Examples of such security items include banknotes, cheques, travellers cheques, vouchers, fiscal stamps, electronic payment cards (credit cards, debit cards etc), identity cards and documents, driving licences, passports, brand protection or authenticity labels or stamps.

Some examples of security devices and methods according to the invention will now be described with reference to the accompanying drawings, in which:—

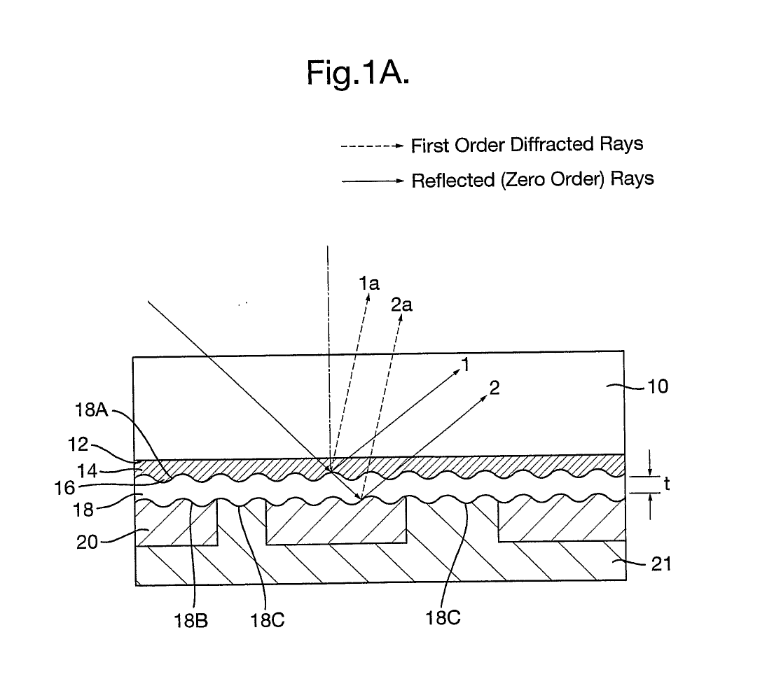

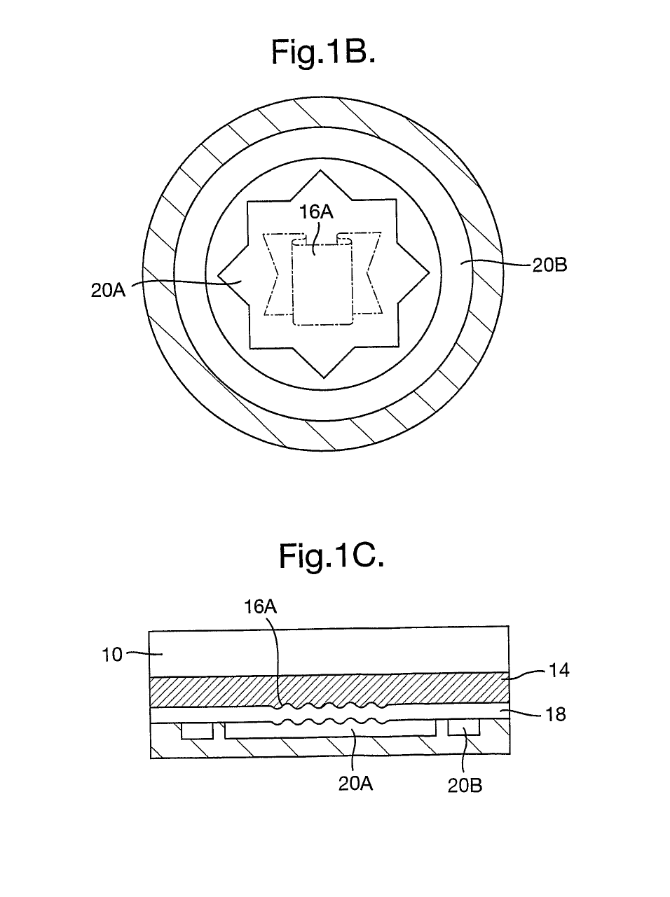

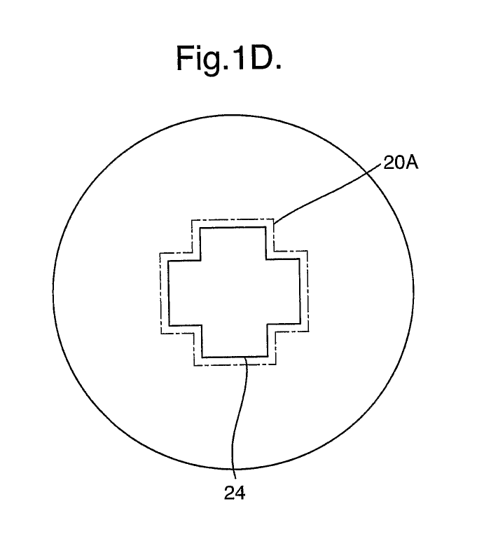

FIGS. 1A, B, C and D show a schematic cross-section of a first example, and a plan view and cross-section of a second example, and a plan view of a third example respectively;

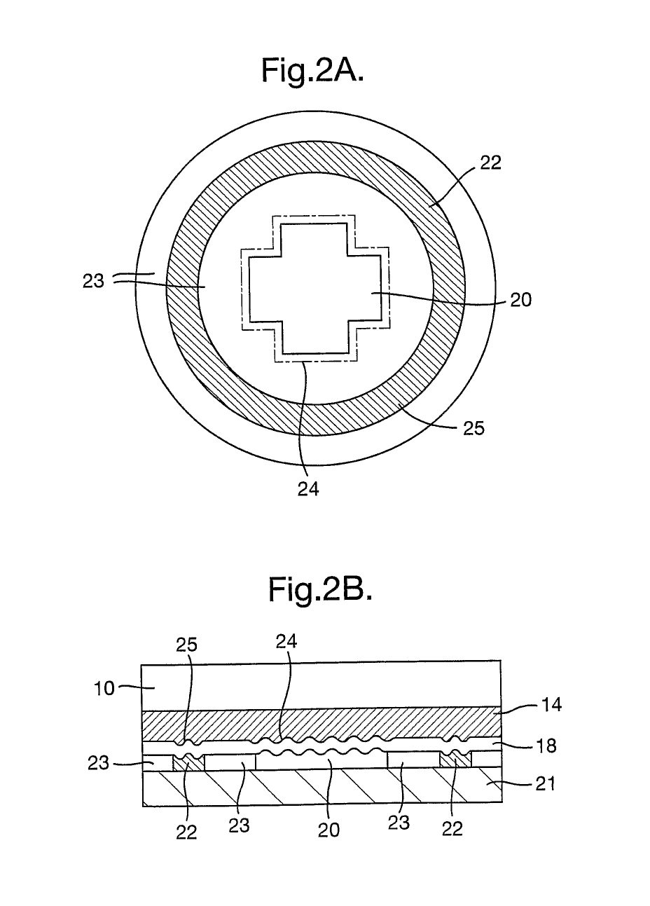

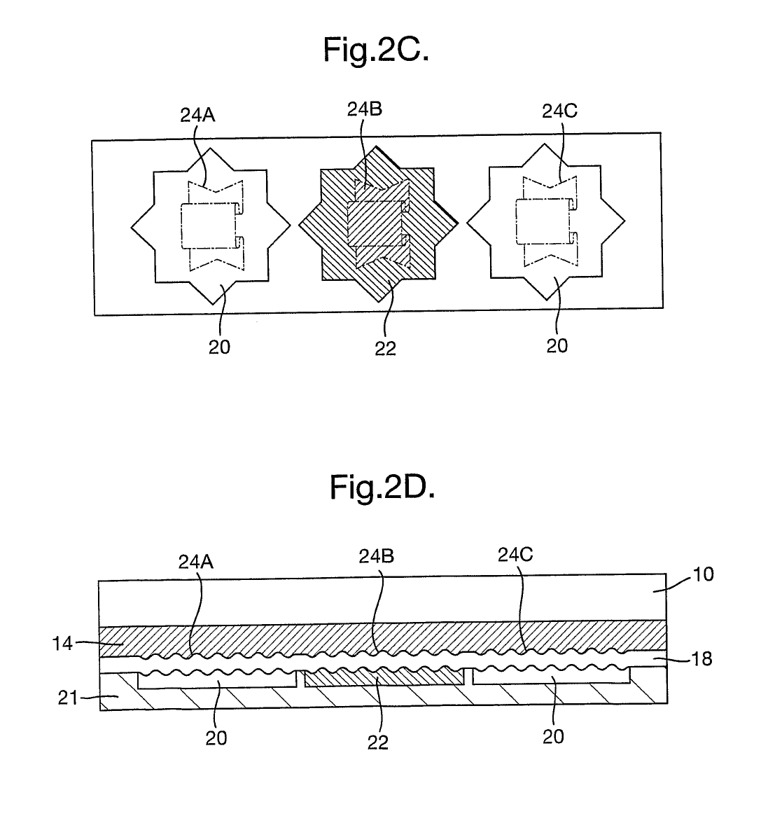

FIGS. 2A and 2C are plan views of fourth and fifth examples whilst 2B and 2D are cross-sectional views respectively of the fourth and fifth examples;

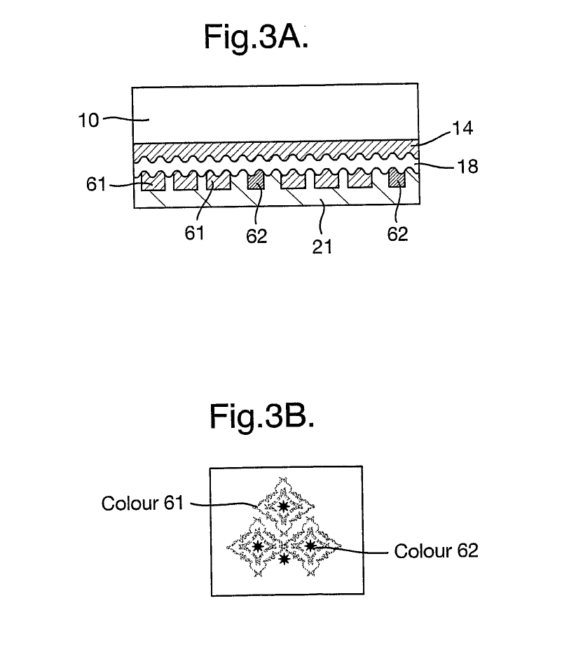

FIGS. 3A and 3B are views similar to FIGS. 2A and 2B respectively but of a third example.

The device shown in FIG. 1A comprises a PET carrier layer 10 of conventional form. A surface 12 of the carrier layer 10 is coated with a lacquer layer 14. In an alternative (not shown), a release layer can be provided between layers 10 and 14 or in a further alternative, the layer 10 is transparent and remains fixed to the layer 14 in use.

The lacquer layer 14 is embossed on a surface 16 with an optically variable relief microstructure defining a hologram or diffraction grating.

The optically variable relief microstructure is then coated with a transparent high refractive index (HRI) layer 18 such as ZnS. The HRI layer is typically applied by vacuum deposition using the techniques of thermal evaporation or sputtering. The HRI layer 18 is sufficiently thin that both surfaces 18A,18B conform to the optically variable relief microstructure 16. Next a metallic ink platelet or flake layer 20 is printed in the form of a security pattern onto the layer 18 and then finally an adhesive coating or coatings 21 are applied to the metallic ink. An example of a suitable metallic ink includes metal platelets with lengths and widths of 1000 nm and a thickness of 25 nm in a binder of 50% nitrocellulose 50% polyurethane. The platelets will contact and conform to the surface relief microstructure of surface 18B.

Customary thicknesses and coat weights:
for PET (10) are 10-50 micrometers but especially 15 -23 micrometers
for embossed lacquer (14) are 0.5-10 gsm but especially 1-5 gsm
for the metallic ink range from 1-10 gsm and especially 2-5 gsm.
For the adhesive coating the coat weights range from 1-10 gsm and especially 1-7 gsm

We next consider the thickness (t) of the HRI layer 18 needed to generate constructive interference between the first and second partial amplitudes. As mentioned previously, determining mathematically the optimum thickness for the HRI layer is fairly complex principally because different points in the incident wave front travel different distances through the HRI layer. This variation becomes greater as the amplitudes of the grating structures present increase and as their periodicities decrease.

However the principles remain the same as that for constructive interference between light rays (partial amplitudes) reflected off the two interfaces of a HRI layer formed between two planar (i.e. optically smooth) layers. Let us consider in FIG. 1A the rays or partial amplitudes (1 and 2) reflected off the first and second interfaces. It will not change the result, but since we are considering reflected light and not diffracted light, let us assume that the grating reliefs are allowed to become an order of magnitude less than the wavelength of incident light. It can then easily be shown that relative to ray 1, ray 2 will travel an additional optical path difference (OPD) through the HRI layer of

2 nt cos θ

Where t=thickness of thin film 18, n=refractive index of HRI layer 18 and θ=angle of incidence/reflection relative to the substrate normal.

Now for the case wherein the platelet ink 20 has a greater refractive index than the HRI layer, which in turn has a greater refractive index than the embossed lacquer layer 14, there will be a phase shift of half a wavelength (i.e. 180 degrees) at both the first and second interface. Consequently the phase difference between the first and second rays (or first and second partial amplitudes) will be determined solely by the OPD.

Hence we have the condition for constructive interference in that the OPD should equal an integer number (P) of wavelengths

2 nt cos θ=p λ

Or rearranging in terms of t

t=pλ/2 n cos θ

Where λ=the wavelength of light under consideration and p is a positive integer We may simplify by considering the lowest order of interference which corresponds to p=1 and also assume an angle of normal incidence such that λ=0 and cos θ=1.

In which case t=λ/2 n or one half of an optical wavelength thick. If we assume a value for λ of 550 nm (middle of the visible spectrum) and a value for n of 2.0 we obtain a value for t of circa 140 nm.

Similarly the condition for destructive interference is that the OPD should equal an odd integer number of half wavelengths which yields

2 nt cos θ=(2 p+1) λ/2

Or rearranging in terms of t

t=(2 p+1) λ/4 n cos θ

In this scenario the lowest order of destructive interference corresponds to p=0—thus assuming normal incidence we obtain that the minimum thickness of HRI layer needed to yield destructive interference is t=λ/4 n

Let us consider the case of interest which is that for constructive interference t=λ/2 n. Here the resultant intensity (that is the brightness) of the light reflected off the two interfaces with amplitudes (A₁ and A₂) will be proportional to the sum of the square of their partial amplitudes. More succinctly

Brightness=(A₁+e A₂)²

where e is a factor defining the relative phase of the partial amplitudes. For the case of constructive interference e=1 and hence

Brightness=A₁²+A₂²+2 A₁A₂

Note generally the first partial amplitude will be a relatively small fraction of the incident amplitude (i.e. circa 12-14%) in which case the brightness of the light reflected off the platelet ink in the absence of the HRI layer will be approximately A₂².

Hence we see that the presence of the HRI layer boosts the perceived brightness of the platelet ink by the value of the terms A₁²+2A₁A₂.

If we further suppose that A₁≈A₂ then the ratio of the brightness of the reflective structure with the HRI layer present to that in which the HRI layer (18) is absent will be given ≈4 A₂²/A₂²≈4. In other words the effect of the HRI layer (with its thickness optimised for constructive interference) for this particular case is to increase the effective brightness of the platelet ink four-fold.

Considering now the effect of the HRI layer (18) on the diffracted light, it should be recognised that although analyzing the OPD through the HRI layer of the diffracted ray (2b) is more complex the same principles apply. There will be an optimum thickness for the HRI layer for which the diffracted rays (2a and 2b) will be substantially in phase and constructively interfere leading to a significant enhancement in the perceived brightness of the diffracted image over that which would be achieved if the platelet ink was coated directly onto the diffractive surface relief. The optimal HRI layer thickness required to achieve constructive interference will depend on the amplitude and periodicity of the diffractive microstructure present, however experimentation has shown that to a first approximation the thickness required to achieve constructive enhancement of the reflected light (i.e. λ/2 n) will suffice.

In regions 18C, the surface of the high refractive index layer 18 contacts the adhesive layer 21. The adhesive layer 21 will typically have a refractive index lower than that of the high refractive index layer 18. Consequently, a light ray reflected at the boundary between the HRI layer 18 and adhesive layer 21 will destructively interfere with the reflection of the same light ray from the boundary between the lacquer layer 14 and the HRI layer 18, thus having the effect of suppressing undesired hologram replay in regions outside where the metal 20 is present.

In FIG. 1B metallic platelet ink is applied in discrete areas 20A,20B registered to the OVD microstructure design 16A. FIG. 1C shows a cross section of FIG. 1B. In the example shown in FIG. 1B the OVD microstructure 16A is registered to the metallic ink by being inside one of the metallic ink regions 20A rather than the OVD being present all-over the device. In a further embodiment the OVD microstructure 24 and the metallic ink 20A may have substantially perfect registration as shown in FIG. 1D in plan-view.

One of the advantages of using a printed metallic ink compared to a vapour deposited metallic layer is the ability to add colourants to the metallic ink, for example by using pigments or dyestuffs. This enables the creation of multicoloured holograms because the reflective layer can be formed by the registered printing of multicoloured metallic inks. Furthermore, the metallic flakes or platelets in the ink can be varied typically from aluminium (silver effect), bronze (gold effect), iron or zinc to give different coloured effects. Colourants can also be added to the embossing lacquer 14, or if a cast cure process is used to form the holographic generating structure then colourants can be added to the UV curable resin. Thus, FIG. 2A illustrates a modified form of the FIG. 1 example in which the metallic ink layer 20 is printed in register to a sequence of multicoloured metallic inks 22 and 23, with each of the inks 20,22,23 having a different colour. It can be seen from FIG. 2B that the location of the different metallic inks 22 and 23 is chosen so that they are in register with respective holographic images 24 and 25 generated by the surface relief microstructure. Thus, the metallic ink layer 20 forms a background in the image of a cross in register with holographic image 24, metallic colour 22 is registered with the OVD microstructure such that it forms a non-holographic region, and metallic colour 23 is in register with the holographic image 25. The device is then coated with a layer of adhesive 21.

FIGS. 2C and 2D illustrate a plan and cross sectional view of a coloured stripe DOVID with 2 different coloured metallic inks registered to the DOVID artwork. The metallic ink layer 20 and metallic coloured ink 22 are printed in register with the respective holographic images generated by the surface relief microstructures 24A-24C.

The printing of the metallic ink also allows it to be localised over the embossing/HRI coating 18. This enables easy registration between the embossing pattern and the printed metallic ink. This allows the creation of a range of designs which can be multicoloured as described above.

The fact that the current invention solves the poor replay of the conventional holograms based on metallic inks means that the advantages of using printed metallic ink can be exploited. One of the key advantages is the registration of the metallic ink to the underlying embossed image and also the ability to print security patterns such as filigree structures down to a resolution of ˜50 μm with conventional printing techniques. A multicoloured filigree structure is shown in FIG. 3. Thus, FIG. 3A illustrates the metallic layer 20 replaced by the discrete printed regions of differently coloured metallic inks 61,62.

The ink 61 is printed in a filigree pattern as can be seen in FIG. 3B surrounding star shapes defined by the ink 62. That is, the holographic image generated by the surface relief microstructure is broken down into portions corresponding to the filigree pattern and star shape.

There are various methods in which these devices can be manufactured.

### Method 1

1. Emboss a holographic pattern into an embossing lacquer or deformable carrier layer 12

2. Vapour deposit a HRI layer 18 over the embossing lacquer 12

3. Print a platelet metallic ink layer 20 in a pattern over the HRI layer 18. The printing step can be any conventional printing process including gravure, flexo, litho and screen printing.

In a further embodiment, the third step of Method 1 will also involve printing multiple different coloured metallic inks in register (see FIG. 2).

The HRI layer is typically zinc sulphide but may also be titanium dioxide or zirconium dioxide.

A metallic platelet ink similar to that described in WO 2005/049745 may be employed. The metallic platelet ink may comprise metal pigment particles and a binder. The metal pigment particles may comprise any suitable metal. The particles may comprise any one or more selected from the group comprising aluminium, stainless steel, nichrome, gold, silver, platinum and copper. Preferably, the particles comprise metal flakes.

The metallic ink layer may be opaque or semitransparent depending on whether underlying information is to be visible.

### Method 2

This is similar to Method 1 except that step 1 is replaced by cast curing or in-situ polymerisation replication (ISPR) of the holographic structure. Techniques such as in-situ polymerisation replication (ISPR) have been developed in which a polymer is cast or moulded against a holographic or other optically variable effect profile continuously while the polymer is held on a substrate, the profile then being retained by curing on or after removal from the profiled mould. One example of this type of technique is UV casting. In a typical UV casting process, a flexible polymeric film is unwound from a reel, where a UV curable polymer resin is then coated onto the polymeric film. If required, a drying stage then takes place to remove solvent from the resin. The polymeric film is then held in intimate contact with the production tool in the form of an embossing cylinder, whereby the optically variable structure defined on the production tool is replicated in the resin held on the polymeric film. UV light is used at the point of contact to cure and harden the resin, and as a final stage, the film supporting the cast and cured resin is rewound onto a reel. Examples of this approach are described in U.S. Pat. Nos. 3,689,346, 4,758,296, 4,840,757, 4,933,120, 5,003,915, 5,085,514, WO 2005/051675 and DE-A-4132476.

The finished device can be applied to an article or document in a variety of different ways, some of which are set out below. The security device could be arranged either wholly on the surface of the document, as in the case of a stripe or patch, or may be visible only partly on the surface of the document in the form of a windowed security thread.

Security threads are now present in many of the world's currencies as well as vouchers, passports, travellers' cheques and other documents. In many cases the thread is provided in a partially embedded or windowed fashion where the thread appears to weave in and out of the paper. One method for producing paper with so-called windowed threads can be found in EP0059056. EP0860298 and WO03095188 describe different approaches for the embedding of wider partially exposed threads into a paper substrate. Wide threads, typically with a width of 2-6 mm, are particularly useful as the additional exposed area allows for better use of optically variable devices such as the current invention.

The device could be incorporated into the document such that regions of the device are viewable from both sides of the document. Techniques are known in the art for forming transparent regions in both paper and polymer substrates. For example, WO8300659 describes a polymer banknote formed from a transparent substrate comprising an opacifying coating on both sides of the substrate. The opacifying coating is omitted in localised regions on both sides of the substrate to form a transparent region. In one embodiment the transparent substrate of the polymer banknote also forms the carrier substrate of the security device.

Alternatively the security device of the current invention could be incorporated in a polymer banknote such that it is only visible from one side of the substrate. In this case the security device is applied to the transparent polymeric substrate and on one side of the substrate the opacifying coating is omitted to enable the security device to be viewed while on the other side of the substrate the opacifying coating is applied over the security device such that it conceals the security device.

Methods for incorporating a security device such that it is viewable from both sides of a paper document are described in EP1141480 and WO03054297. In the method described in EP1141480 one side of the device is wholly exposed at one surface of the document in which it is partially embedded, and partially exposed in windows at the other surface of the substrate.

In the case of a stripe or patch the security device is formed on a carrier substrate and transferred to the security substrate in a subsequent working step. The device can be applied to the security substrate using an adhesive layer. The adhesive layer 15 is applied either to the device, or the surface of the security substrate to which the device is to be applied. After transfer, the carrier substrate may be removed, leaving the security device as the exposed layer. Alternatively the carrier layer can remain as part of the structure acting as an outer protective layer.

Following the application of the security device 10, the security substrate undergoes further standard security printing processes to create a secure document, including one or all of the following; wet or dry lithographic printing, intaglio printing, letterpress printing, flexographic printing, screen printing, and/or gravure printing.

1. A security device comprising a transparent base layer having a surface provided with an optically variable relief microstructure; a transparent high refractive index layer on the said surface of the base layer, the high refractive index layer conforming to the surface relief microstructure; and a reflective metal layer printed on the transparent high refractive index layer, characterized in that the metal layer is printed in the form of a pattern;
and in that the thickness of the transparent high refractive index layer is selected so as to achieve constructive interference of light with a wavelength λ in the range 450-650 nm reflected at each surface of the high refractive index layer.

2. A device according to claim 1, wherein the optically variable relief microstructure defines a diffraction grating or hologram.

3. A device according to claim 1, wherein the base layer comprises a lacquer or a resin.

4. A device according to claim 3, wherein the optically variable relief microstructure is embossed into the said surface of the base layer.

5. A device according to claim 1, wherein the optically variable relief microstructure is formed by a cast/cure process in the said surface of the base layer.

6. A device according to claim 1, wherein the transparent high refractive index layer is formed from one of ZnS₁ TiO₂ and ZrO₂.

7. A device according to claim 1, wherein the thickness of the transparent high refractive index layer is approximately λ/2 n, where n is the refractive index of the high refractive index layer.

8. A device according to claim 1, wherein the wavelength λ is about 550 nm.

9. A device according to claim 1, wherein the refractive index of the transparent high refractive index layer is in the range 1.8-2.5.

10. A device according to claim 1, wherein the metal layer is formed by metallic particles such as flakes or platelets.

11. A device according to claim 10, wherein the metallic particles conform to the surface relief microstructure.

12. A device according to claim 10, wherein the metallic particles comprise metal flakes or platelets with an average diameter of at least 1 micron.

13. A device according to claim 10, wherein the metallic particles have a thickness less than 100 nm.

14. A device according to claim 1, wherein the metal layer is formed by inks of different colours.

15. A device according to claim 10, wherein the metal layer is formed by inks of different colors, and the metallic particles have different colors.

16. A device according to claim 14, wherein the inks contain different colourants.

17. A device according to claim 1, wherein the metal is one of aluminium, copper, zinc, Nickel, chrome, gold, silver, platinum, or any other metals or associated alloys.

18. A device according to claim 1, wherein the metal layer is printed in the form of a pattern registered to the pattern(s) generated by the optically variable relief microstructure.

19. A device according to claim 1, wherein the pattern is a security pattern.

20. An article of value carrying a security device according to claim 1.

21. An article according to claim 20, chosen from the group comprising banknotes, cheques, travellers cheques, vouchers, fiscal stamps, electronic payment cards (credit cards, debit cards etc), identity cards and documents, driving licences, passports, brand protection or authenticity labels or stamps.

22. A method of manufacturing a security device, the method comprising providing a transparent base layer with a surface having an optically variable relief microstructure; providing a transparent high refractive index layer on the said surface of the base layer, the high refractive index layer conforming to the surface relief microstructure;
and providing a reflective metal layer on the transparent high refractive index layer, characterized in that the metal layer is printed in the form of a pattern; and in that the thickness of the transparent high refractive index layer is selected so as to achieve constructive interference of light with a wavelength λ in the range 450-650 nm reflected at each surface of the high refractive index layer.

23. A method according to claim 22, wherein the printing step comprises one of gravure, rotogravure, flexographic, lithographic, offset, letterpress intaglio and/or screen printing.

24. A method according to claim 22, wherein the printing step employs one or more inks containing a binder and metal flakes or platelets.

25. A method according to claim 24, wherein the binder is selected from the group comprising nitrocellulose, ethyl cellulose, cellulose acetate, cellulose acetate propionate (CAP), cellulose acetate butyrate (CAB), alcohol soluble propionate (ASP), vinyl chloride, vinyl acetate copolymers, vinyl acetate, vinyl, acrylic, polyurethane, polyamide, rosin ester, hydrocarbon, aldehyde, ketone, urethane, polyethyleneterephthalate, terpene phenol, polyolefin, silicone, cellulose, polyamide and rosin ester resins.

26. A method according to claim 25, wherein the binder comprises 50% nitrocellulose and 50% polyurethane.

27. A method according to claim 22, wherein the base layer surface is provided with the optically variable relief microstructure by embossing.

28. A method according to claim 22, wherein the base layer surface is provided with the optically variable relief microstructure by casting and then curing.

29. A method according to claim 22 for manufacturing a security device comprising a transparent base layer having a surface provided with an optically variable relief microstructure; a transparent high refractive index layer on the said surface of the base layer, the high refractive index layer conforming to the surface relief microstructure; and a reflective metal layer printed on the transparent high refractive index layer, characterized in that the metal layer is printed in the form of a pattern; and in that the thickness of the transparent high refractive index layer is selected so as to achieve constructive interference of fight with a wavelength λ in the range 450-650 nm reflected at each surface of the high refractive index layer.

30. A device according to claim 10, wherein the metallic particles comprise metal flakes or platelets with an average diameter of greater than 5 microns.

31. A device according to claim 10, wherein the metallic particles comprise metal flakes or platelets with an average diameter of at least 10 microns.

32. A device according to claim 10, wherein the metallic particles have a thickness in the range of 15-100 nm.

33. A device according to claim 10, wherein the metallic particles have a thickness in the range of 25-50 nm.

34. A device according to claim 17, wherein the metal is one of the associated alloys such as copper-aluminium, copper-zinc or nickel-chrome.

35. A device according to claim 19, wherein the pattern is in the form of a filigree effect.

36. A device according to claim 35, wherein the filigree effect has minimum dimension in the order of 50 microns.
